(19) United States
(12) Patent Application Publication
(10) Pub. No.: US 2015/0213019 A1
(43) Pub. Date: Jul. 30, 2015

(54) CONTENT SWITCHING USING SALIENCE

(71) Applicant: FUJITSU LIMITED, Kawasaki-shi (JP)

(72) Inventors: David L. MARVIT, San Francisco, CA (US); Jeffrey UBOIS, Chicago, IL (US)

(73) Assignee: FUJITSU LIMITED, Kawasaki-shi (JP)

(21) Appl. No.: 14/165,328

(22) Filed: Jan. 27, 2014

(51) Int. Cl. G06F 17/30; G06Q 30/02

(52) U.S. Cl. CPC G06F 17/3053; G06Q 30/0242

(57) ABSTRACT

A method of switching content based on salience data may include providing a first time-based content item to a user through a user interface. The method may also include receiving physiological data from at least one physiological sensor as the user interacts with the first time-based content item. The method may also include determining a salience score based at least in part on the physiological data. The method may also include, in the event the salience score is below a threshold value, presenting a second time-based content item to the user through the user interface.

### FIELD

The embodiments discussed herein are related to content switching using salience.

### BACKGROUND

The availability and prevalence of music and videos has increased drastically in the last ten years with the advent of the Internet, smartphones and tablets. Content may be streamed online or downloaded to a device through any number of different providers such as, for example, Netflix®, Apple®, Hulu®, and Amazon®, to name a few. Moreover, these providers offer so much content that users are faced with the difficult task of choosing content that they may enjoy. Users choose content based on any number of factors and are often disappointed with their choice.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of switching content based on salience data may include providing a first time-based content item to a user through a user interface. The method may also include receiving physiological data from at least one physiological sensor as the user is exposed to the first time-based content item. The method may also include determining a salience score based at least in part on the physiological data. The method may also include, in the event the salience score is below a threshold value, presenting a second time-based content item to the user through the user interface.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example system for associating eye tracking data and physiological data with content in a document according to at least one embodiment described herein.

FIG. 2 is a block diagram of an example eye tracking subsystem according to at least one embodiment described herein.

FIG. 3 is a block diagram of an example electroencephalography (EEG) system according to at least one embodiment described herein.

FIG. 4 illustrates an example EEG headset with a plurality of EEG sensors according to at least one embodiment described herein.

FIG. 5 illustrates an example document that may be consumed by a user through a display according to at least one embodiment described herein.

FIG. 6 is a flowchart of an example process for associating physiological data and eye tracking data with content in a document according to at least one embodiment described herein.

FIG. 7 is a flowchart of an example process for switching content based on salience data according to at least one embodiment described herein.

### DESCRIPTION OF EMBODIMENTS

There are many systems known in the art that provide content to users. Such systems may be referred to herein as content providers. These content providers may allow users to stream and/or download content to their electronic devices. Many content providers provide access to more content than a user may possibly consume. Choosing content from such a large selection of content may be difficult when user interests vary between different users and vary over time. When a user is disinterested in the content they are watching or otherwise consuming, they may have to stop the content and select another content item for consumption. There is nothing that measures the salience of the content and then determines whether to automatically change the content to another content item based on the salience of the content.

The salience of an item is the state or quality by which it stands out relative to its neighbors. Generally speaking, salience detection may be an attentional mechanism that facilitates learning and survival by enabling organisms to focus their limited perceptual and cognitive resources on the most pertinent subset of the available sensory data. Salience may also indicate the state or quality of content relative to other content based on a user's subjective interests in the content. Salience in document organization may enable organization based on how pertinent the document is to the user and/or how interested the user is in content found within the document.

The focus of a user on content may be related to salience. Focus may include the amount of time the user spends consuming content relative to other content as well as the physiological or emotional response of the user to the content.

Salience and/or focus may be measured indirectly. For instance, the salience may be measured at least in part by using devices that relate to a user's physiological and/or emotional response to the content, for example, those devices described below. The salience and/or focus may relate to how much or how little the user cares about or is interested in what they are looking at. Such data, in conjunction with eye tracking data and/or keyword data, may suggest the relative importance or value of the content to the user. The focus may similarly be measured based in part on the user's physiological and/or emotional response and in part by the amount of time the user consumes the content using, for example, eye tracking data. A salience score may represent a numerical number that is a function of physiological data recorded from one or more physiological sensors and/or eye tracking data recorded from an eye tracking subsystem.

Embodiments of the present invention will be explained with reference to the accompanying drawings.

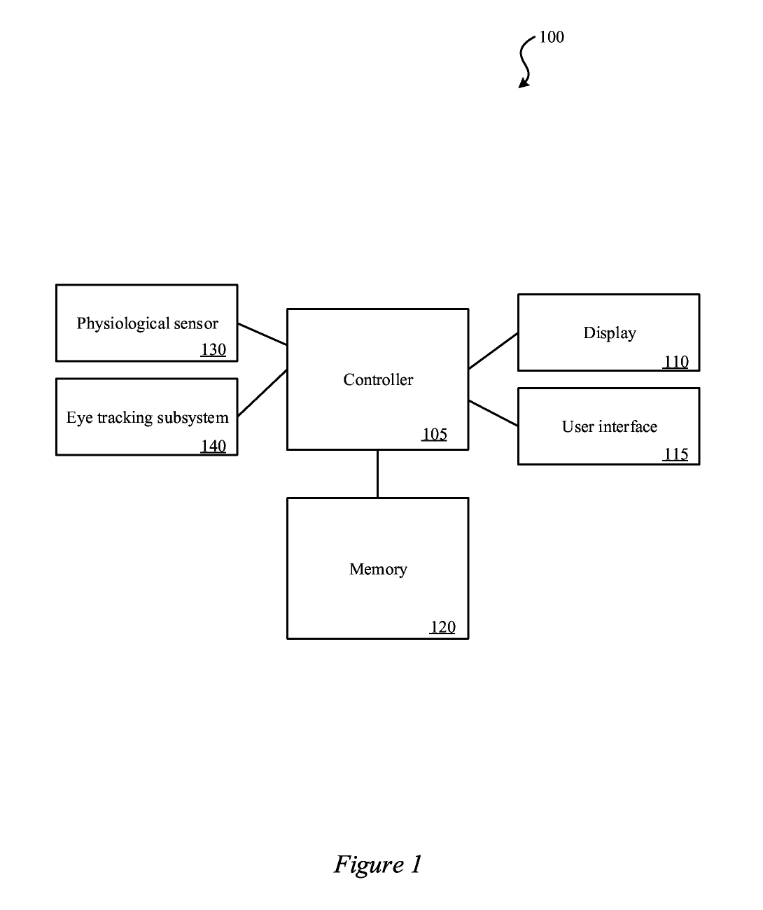

FIG. 1 is a block diagram of an example system 100 for associating eye tracking data and physiological data with content in a document in accordance with at least one embodiment described herein. The system 100 may include a controller 105, a display 110, a user interface 115, and a memory 120, which may, in at least one embodiment described herein, be part of a standalone or off-the-shelf computing system. The system 100 may include various other components without limitation. The system 100 may also include an eye tracking subsystem 140 and/or a physiological sensor 130. In at least one embodiment described herein, the physiological sensor 130 may record brain activity data, for example, using an EEG system. In at least one embodiment described herein, a physiological sensor other than an EEG system may be used.

In at least one embodiment described herein, the controller 105 may be electrically coupled with and control the operation of each component of the system 100. For instance, the controller 105 may execute a program that displays a document stored in the memory 120 on the display 110 and/or through speakers or another output device in response to input from a user through the user interface 115. The controller 105 may also receive input from the physiological sensor 130, and the eye tracking subsystem 140.

As described in more detail below, the controller 105 may execute a process that associates inputs from one or more of an EEG system, the eye tracking subsystem 140, and/or other physiological sensors 130 with content within a document displayed in the display 110 and may save such data in the memory 120. Such data may be converted and/or saved as salience and/or focus data (or scores) in the memory 120. The controller 105 may alternately or additionally execute or control the execution of one or more other processes described herein.

The physiological sensor 130 may include, for example, a device that performs functional magnetic resonance imaging (fMRI), positron emission tomography, magnetoencephalography, nuclear magnetic resonance spectroscopy, electrocorticography, single-photon emission computed tomography, near-infrared spectroscopy (NIRS), Galvanic Skin Response (GSR), Electrocardiograms (EKG), pupillary dilation, Electrooculography (EOG), facial emotion encoding, reaction times, and/or event-related optical signals. The physiological sensor 130 may also include a heart rate monitor, galvanic skin response (GSR) monitor, pupil dilation tracker, thermal monitor or respiration monitor.

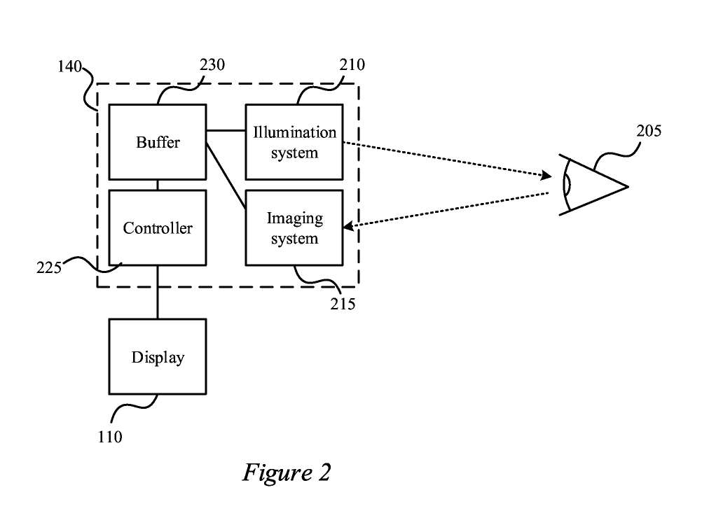

FIG. 2 is a block diagram of an example embodiment of the eye tracking subsystem 140 according to at least one embodiment described herein. The eye tracking subsystem 140 may measure the point of gaze (where one is looking) of the eye 205 and/or the motion of the eye 205 relative to the head. In at least one embodiment described herein, the eye tracking subsystem 140 may also be used in conjunction with the display 110 to track either the point of gaze or the motion of the eye 205 relative to information displayed on the display 110. The eye 205 in FIG. 2 may represent both eyes and eye tracking subsystem may perform the same function on one or both eyes.

The eye tracking subsystem 140 may include an illumination system 210, an imaging system 215, a buffer 230, and a controller 225. The controller 225 may control the operation and/or function of the buffer 230, the imaging system 215, and/or the illumination system 210. The controller 225 may be the same controller as the controller 105 or a separate controller. The illumination system 210 may include one or more light sources of any type that direct light, for example, infrared light, toward the eye 205. Light reflected from the eye 205 may be recorded by the imaging system 215 and stored in the buffer 230. The imaging system 215 may include one or more imagers of any type. The data recorded by the imaging system 215 and/or stored in the buffer 230 may be analyzed by the controller 225 to extract, for example, eye rotation data from changes in the reflection of light off the eye 205. In at least one embodiment described herein, corneal reflection (often called the first Purkinje image) and the center of the pupil may be tracked over time. In other embodiments, reflections from the front of the cornea (the first Purkinje image) and the back of the lens (often called the fourth Purkinje image) may be tracked over time. In other embodiments, features from inside the eye may be tracked such as, for example, the retinal blood vessels. In yet other embodiments, eye tracking techniques may use the first Purkinje image, the second Purkinje image, the third Purkinje image, and/or the fourth Purkinje image singularly or in any combination to track the eye. In at least one embodiment described herein, the controller 225 may be an external controller.

In at least one embodiment described herein, the eye tracking subsystem 140 may be coupled with the display 110. The eye tracking subsystem 140 may also analyze the data recorded by the imaging system 215 to determine the eye position relative to a document displayed on the display 110. In this way, the eye tracking subsystem 140 may determine the amount of time the eye viewed specific content items within a document on the display 110. In at least one embodiment described herein, the eye tracking subsystem 140 may be calibrated with the display 110 and/or the eye 205.

The eye tracking subsystem 140 may be calibrated in order to use viewing angle data to determine the portion (or content items) of a document viewed by a user over time. The eye tracking subsystem 140 may return view angle data that may be converted into locations on the display 110 that the user is viewing. This conversion may be performed using calibration data that associates viewing angle with positions on the display.

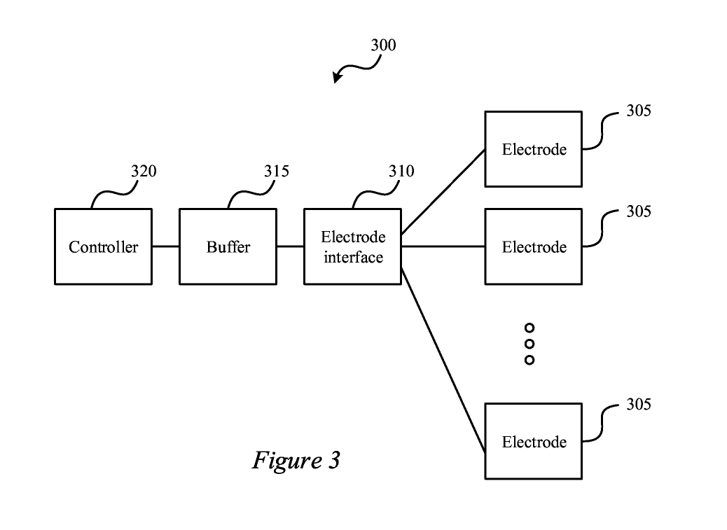

FIG. 3 is a block diagram of an example embodiment of an EEG system 300 according to at least one embodiment described herein. The EEG system 300 is one example of a physiological sensor 130 that may be used in various embodiments described herein. The EEG system 300 may measure voltage fluctuations resulting from ionic current flows within the neurons of the brain. Such information may be correlated with how focused and/or attentive the individual is when viewing a document or a portion of the document being viewed while EEG data is being collected. This information may be used to determine the focus and/or salience of the document or a portion of the document. The data collected from the EEG system 300 may include either or both the brain's spontaneous electrical activity or the spectral content of the activity. The spontaneous electrical activity may be recorded over a short period of time using multiple electrodes placed on or near the scalp. The spectral content of the activity may include the type of neural oscillations that may be observed in the EEG signals. While FIG. 3 depicts one type of EEG system, any type of system that measures brain activity may be used.

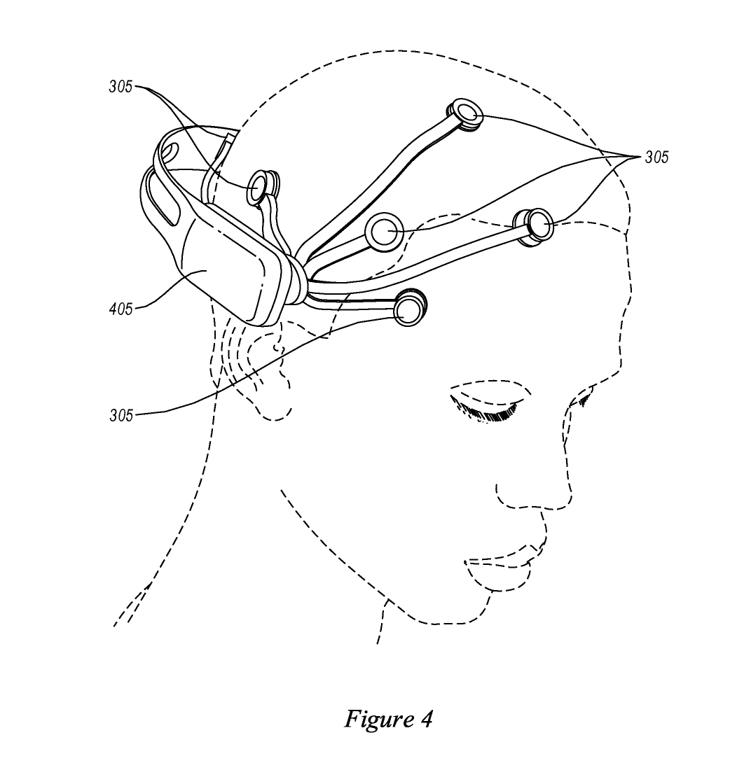

The EEG system 300 may include a plurality of electrodes 305 that are configured to be positioned on the scalp of a user. The electrodes 305 may be coupled with a headset, hat, or cap (see, for example, FIG. 4) that positions the electrodes on the scalp of a user when in use. The electrodes 305 may be saline electrodes, post electrodes, gel electrodes, etc. The electrodes 305 may be coupled with a headset, hat, or cap following any number of arranged patterns such as, for example, the pattern described by the international 10-20 system standard for the electrodes 305 placements.

The electrodes 305 may be electrically coupled with an electrode interface 310. The electrode interface 310 may include any number of components that condition the various electrode signals. For example, the electrode interface 310 may include one or more amplifiers, analog-to-digital converters, filters, etc. coupled with each electrode. The electrode interface 310 may be coupled with buffer 315, which stores the electrode data. The controller 320 may access the data and/or may control the operation and/or function of the electrode interface 310, the electrodes 305, and/or the buffer 315. The controller 320 may be a standalone controller or the controller 105.

The EEG data recorded by The EEG system 300 may include EEG rhythmic activity, which may be used to determine a user's salience when consuming content with a document. For example, theta band EEG signals (4-7 Hz) and/or alpha band EEG signals (8-12 Hz) may indicate a drowsy, idle, relaxed user, and result in a low salience score for the user while consuming the content. On the other hand, beta EEG signals (13-30 Hz) may indicate an alert, busy, active, thinking, and/or concentrating user, and result in a high salience score for the user while consuming the content.

FIG. 4 illustrates an example EEG headset 405 with a number of Electrodes 305 according to at least one embodiment described herein. The Electrodes 305 may be positioned on the scalp using the EEG headset 405. Any number of configurations of the Electrodes 305 on the EEG headset 405 may be used.

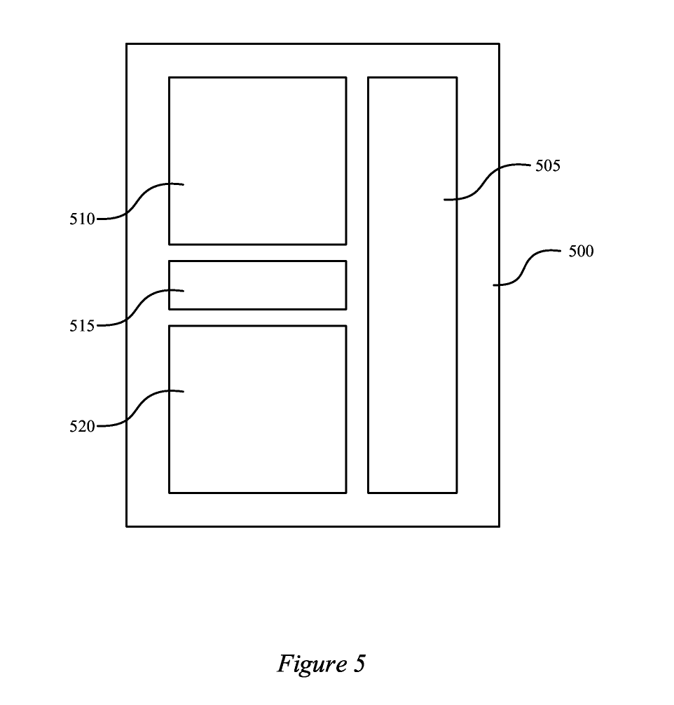

FIG. 5 illustrates an example document that may be consumed by a user through the display 110 and/or through speakers or another output device according to at least one embodiment described herein. In this example, the document 500 includes an advertisement 505, which may include text, animation, video, and/or images, a body of text 510, an image 515, and a video 520. Advertisement 505 and/or video 520 may be time-based content and may include audio. Various other content or content items may be included within documents 500.

The term “content item” refers to one of the advertisement 505, the text 510, the image 515, and the video 520; the term may also refer to other content that may be present in a document. The term “content item” may also refer to a single content item such as music, video, flash, text, a PowerPoint presentation, an animation, an HTML document, a podcast, a game, etc. Moreover, the term “content item” may also refer to a portion of a content item, for example, a paragraph in a document, a sentence in a paragraph, a phrase in a paragraph, a portion of an image, a portion of a video (e.g., a scene, a cut, or a shot), etc. Moreover, a content item may include sound, media or interactive material that may be provided to a user through a user interface that may include speakers, a keyboard, touch screen, gyroscopes, a mouse, heads-up display, instrumented “glasses”, and/or a hand held controller, etc. The document 500 shall be used to describe various embodiments described herein.

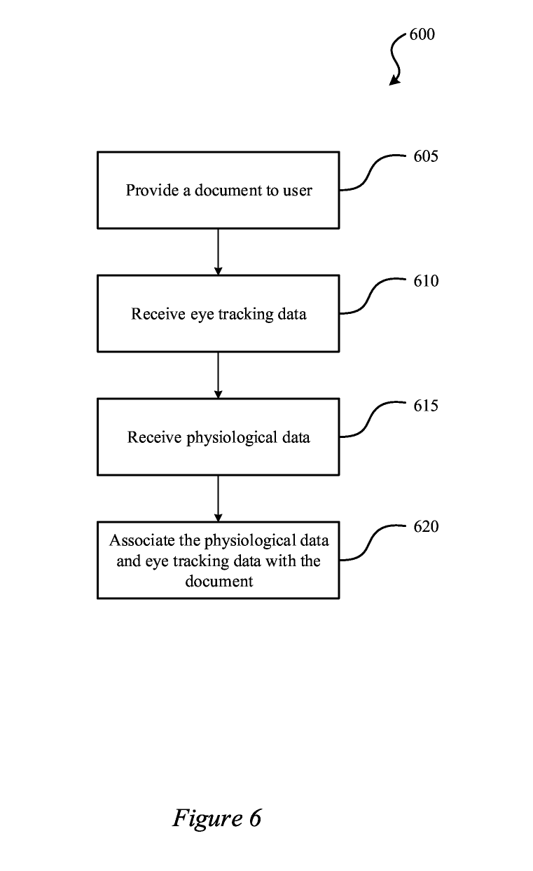

FIG. 6 is a flowchart of an example process 600 for associating physiological data and eye tracking data with content in document 500 according to at least one embodiment described herein. Process 600 begins at block 605. Document 500 is provided to a user, for example, through the display 110 and/or user interface 115. At block 610 eye tracking data is received from, for example, the eye tracking subsystem 140. Eye tracking data may include viewing angle data that includes a plurality of viewing angles of the user's eye over time as the user views portions of the content in document 500. The viewing angle data may be used to determine which specific portions of the display the user was viewing at a given time. This determination may be made based on calibration between the user, the display 110, and eye tracking subsystem 140. For example, viewing angle data may be converted to display coordinates. These display coordinates may identify specific content items based on such calibration data, the time, and details about the location of content items within document 500 being viewed.

At block 615 physiological data is received. Physiological data may be received, for example, from The EEG system 300 as physiological data recorded over time. Various additional or different physiological data may be received. The physiological data may be converted or normalized into salience data (and/or focus data). At block 620 the salience data and the eye tracking data may be associated with the content in document 500 based on the time the data was collected. Table 1, shown below, is an example of eye tracking data and salience data associated with the content in document 500.

TABLE 1

| Time | | Average |
|---|---|---|
| (seconds) | Content | Salience Score |
| 10 | Advertisement 505 | 40 |
| 10 | Image 515 | 45 |
| 25 | Video 520 | 56 |
| 145 | Image 515 | 70 |
| 75 | Text 510 | 82 |
| 10 | Advertisement 505 | 52 |
| 230 | Image 515 | 74 |
| 135 | Text 510 | 88 |
| 10 | Video 520 | 34 |

The first column of Table 1 is an example of an amount of time a user spent consuming content items listed in the second column before moving to the next content item. Note that the user moves between content items and consumes some content items multiple times. As shown, summing the amount of time the user spends interacting with specific content items; the user interacts with the advertisement 505 for a total of 20 seconds, the text 510 for a total of 210 seconds, the image 515 for a total of 385 seconds, and the video 520 for a total of 35 seconds. Thus, the user spends most of the time viewing the image 515. This data is useful in describing how long the user is looking at the content, but does not reflect how interested, salient, or focused the user is when consuming the content in document 500.

The third column lists the average salience score of the content. In this example, the salience score is normalized so that a salience score of one hundred represents high salience and/or focus and a salience score of zero represents little salience and/or focus. The salience score listed in Table 1 is the average salience score over the time the user was consuming the listed content item. The average salience score for both times the user interacted with the advertisement 505 is 46, the average salience score for the text 510 is 85, the average salience score for the image 515 is 63, and the average salience score for the video 520 is 45. Thus, in this example, the text 510 has the highest salience even though the user consumed the text 510 for the second longest period of time, and the image 515 has the second highest salience score even though it was consumed the longest period of time.

As shown in Table 1, process 600 may associate specific content items of document 500 with salience data based on the eye tracking data. Furthermore, process 600 may also associate specific content with the amount of time the content was consumed by the user. The salience data and the time data associated with the content may be used in a number of ways. For example, metadata may be stored with document 500 or as a separate metadata file that tags the specific content with either or both the salience data and/or the time the content was consumed. This metadata may also associate keywords or other semantic information with the content in document 500.

Process 600 may be used, for example, to tag the content in document 500 with eye tracking data and/or salience data. For example, content 505 may be tagged with a salience score of 46, the text 510 may be tagged with a salience score of 85, the image 515 may be tagged with a salience score of 63, and the video 520 may be tagged with a salience score of 45. In at least one embodiment described herein, the content may also be tagged with the amount of time the user consumes each content item or the percentage of time the user consumes each content time relative to the amount of time the user consumes document 500. In at least one embodiment described herein, the content may be tagged with a score that is a combination of the salience and the time the user consumed the content. The content may be tagged in a separate database or file, or embedded with the document 500.

Furthermore, the process 600 may be repeated with any number of documents. For instance, each of these documents may be provided to the user and associated with eye tracking data and/or physiological data as the user consumes each document, which may then be stored in a database.

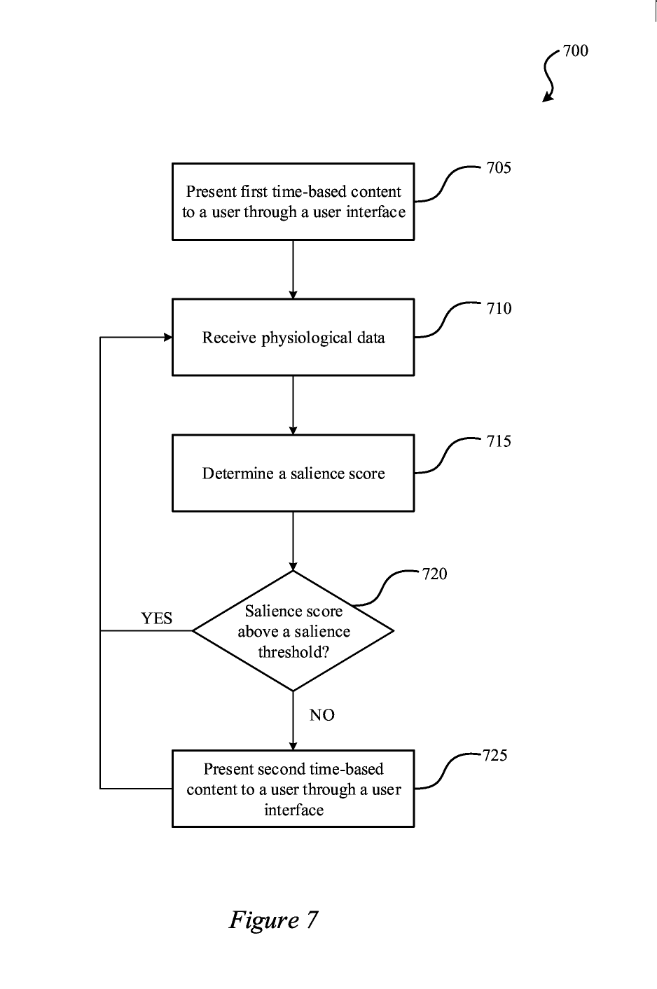

FIG. 7 is a flowchart of an example process 700 for switching time-based content based on salience data according to at least one embodiment described herein. For example, time-based content may be embedded within document 500 such as video 520 or be presented as a standalone content item. The salience data may be generated and/or collected as described above. The process 700 may begin at block 705 where a first time-based content item is presented to a user through the display 110 and/or the user interface 115 (e.g., through speakers). A time-based content item may include any type of content that varies over time; for example, a video, live broadcast performance, music, a slideshow, a PowerPoint presentation, an animation, a game, a lecture, a radio play, a podcast, etc. The time-based content item may be presented in any format, and/or may be presented within document 500 or may be the entirety of document 500. Thus, any discussions, description or mention of document 500 and/or a content item embedded within document 500 may refer to a time-based content item. The first time-based content item may be presented to the user, for example, through a computer screen and speakers, a tablet device, a smartphone, a portable media device, a television, etc. The first time-based content item, for example, may include video 520.

At block 710, physiological data may be received as the user interacts with the first time-based content item. The physiological data may include, for example, eye tracking data received from the eye tracking system 140 and/or EEG data. Any other type or combination of physiological data may be used.

At block 715, a salience score may be determined from the physiological data. The salience score may represent a numerical number that is a function of the physiological data recorded from one or more physiological sensors 130 and/or eye tracking data recorded from the eye tracking system 140. Any function may be used that translates physiological sensor data to salience data. The salience score may be a numerical representation of the relative interest and/or focus of the user when interacting with the content. According to at least one embodiment described herein, the salience score may be determined from a running average of the physiological data and/or the eye tracking data in order to average out short periods of disinterest or heightened interest. For example, in the example provided above in in process 600 the salience score for video 520 is 45 and the salience score for advertisement 505 is 46.

At block 720, the salience score may be compared with a salience threshold value. If the salience score is above the salience threshold value, it may be assumed the user is interested and the process 700 may return to block 710. If the salience score is below the salience threshold value, it may be assumed the user is disinterested and a second time-based content item may be presented to the user through the user interface at block 725. The presentation of the first time-based content may, for example, be stopped at block 725.

Following block 725, the process 700 may return to block 710 and the process 700 may be repeated while the user is exposed to the second time-based content item. That is, the second time-based content becomes the first time-based content during the second operation of process 700. The second time-based content item, for example, may be selected from a play list, a wish list, or another list of time-based content items. For example, if the salience threshold is 60, then video 520 may be changed to another video because the video has a salience score of 45. Moreover, advertisement 505 may also be changed because it has a salience score of 46.

The first time-based content item and/or the second time-based content item may be downloaded to the user's device and/or may be streamed to the user's device.

According to at least one embodiment described herein, the second time-based content item may be selected based on portions of previously consumed content (e.g., the first time-based content item) where the user's salience score was above the salience threshold value. For example, if the user is watching a movie and has a high salience score while consuming an action sequence and later has a salience score that is below the salience threshold while consuming dialogue, an action movie may be selected for the second time-based content item.

According to at least one embodiment described herein, the second time-based content item may be selected based on the user's previously consumed content and the salience of the previously consumed content. For example, if the user has high salience scores for comedies, then the second time-based content item may be a comedy. Additionally, the second time-based content item may be selected based on salience scores of another user (or other users) that have similar salience scores for previously consumed content.

According to at least one embodiment described herein, the second time-based content item may be a preview of a time-based content item that the user is likely to have a salience score above the salience threshold. Once the preview has been consumed or while the preview is being consumed, the user may be provided with an option to purchase the second time-based content item, for example, from a media store.

According to at least one embodiment described herein, the salience threshold may vary between users, between content, and/or over time. For example, a user may set a salience threshold level based on mood or preferences of the day. Moreover, some users may prefer to have a higher salience threshold than other users and vice versa. As another example, the salience threshold may vary over the course of a day. The salience threshold may be higher when the user is tired (at night) and lower during the day.

According to at least one embodiment described herein, some content items may have a salience threshold that varies over time, for example, if it is known that the user has a low tolerance for dialogue scenes and a preference for action movies. When the user is consuming a movie with a lot of action scenes but with some dialogue scenes, the salience threshold may be lowered during the dialogue scenes to ensure that the movie is not changed too quickly. Alternatively, the salience score may be averaged over periods of time to ensure a heightened average salience score despite a lower salience score during dialogue scenes.

According to at least one embodiment described herein, a salience threshold for specific types of content may be determined based on a user's history and/or the salience of the previously consumed content. For instance, if the user has a history of enjoying pop music, the threshold for salience may be higher than for alternative music or vice versa.

According to at least one embodiment described herein, a second salience threshold that is lower than the salience threshold may be used to evaluate whether the user is asleep. If the user's salience score is below the second salience threshold, then the user interface may turn off, the first time-based content item may no longer be displayed, and/or the first time-based content item may be stopped or paused.

For example, a user may be consuming a video (the first time-based content item) on a computing device (e.g., a tablet, television, or smartphone) that includes a user interface. The video may be streamed over a network from a network-based streaming host (e.g., Netflix®, Apple®, Hulu®, and Amazon®, etc.). The user may also be interacting with a physiological sensor such as, for example, EEG system 300 or a heart rate monitor. The physiological sensor may or may not be coupled with the user interface. For instance, the physiological sensor may be coupled with a computing device or controller that is in communication with the streaming host. The physiological data may be converted to a salience score. For example, the physiological data may be the salience score. As another example, the physiological data may be converted to a salience score using a mathematical function that may use other input values.

In the event the salience score is below a threshold value as determined by the computing device, a message may be sent to the network-based streaming host to stop streaming the video and to start streaming another video (e.g., the second time-based content item). In the event the salience score is below a threshold value as determined by the network-based streaming host, the network-based streaming host may stop streaming the video and may start streaming another video (e.g., the second time-based content item). The other video may be selected based on the salience data of the user as they interact with the video or based on historical salience data consuming another video.

As another example, the user may be listening to music on a portable music device that is coupled with a physiological sensor (e.g., a heart rate monitor). The portable music device may change the music provided to the user based on a salience score from data collected from the physiological sensor.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. According to at least one embodiment described herein, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of switching content based on salience data, the method comprising:
providing a first time-based content item to a user through a user interface;
receiving physiological data from at least one physiological sensor as the user interacts with the first time-based content item;
determining a salience score based at least in part on the physiological data; and
in the event the salience score is below a threshold value, presenting a second time-based content item to the user through the user interface.

2. The method according to claim 1, wherein the first time-based content item comprises content selected from a group consisting of a video, music, a slide show, a presentation, and an animation.

3. The method according to claim 1, wherein the second time-based content item is different than the first time-based content item.

4. The method according to claim 1, wherein the physiological data comprises one or more data selected from a group consisting of eye tracking data, electroencephalography (EEG) data, magnetic resonance imaging (MRI) data, Galvanic Skin Response (GSR) monitor, and heart rate data.

5. The method according to claim 1, wherein the salience score comprises an average salience score over a period of time.

6. The method according to claim 1, wherein the threshold value varies over time depending on the first time-based content item.

7. The method according to claim 1, wherein the second time-based content item is selected from a plurality of content items based at least in part on salience data of the user and historical salience data of other users interacting with the second time-based content item, wherein salience data of the user includes salience scores for time-based content items consumed by the user.

8. A system of switching content based on salience data, the system comprising:
a user interface for presenting time-based content items to a user;
a physiological sensor configured to record a physiological response of the user over time as the user consumes the time-based content items via the user interface; and
a controller coupled with the user interface and the physiological sensor, the controller configured to:
provide a first time-based content item to the user through the user interface;
receive physiological data from the physiological sensor as the user consumes the first time-based content item;
determine a salience score based at least in part on the physiological data; and
in the event the salience score is below a threshold value, provide a second time-based content item to the user through the user interface.

9. The system according to claim 8, wherein the first time-based content item comprises content selected from a group consisting of a video, music, a slide show, a presentation, and an animation.

10. The system according to claim 8, wherein the second time-based content item is different than the first time-based content item.

11. The system according to claim 8, wherein the physiological sensor comprises a sensor selected from a group consisting of an eye tracking device, an electroencephalography (EEG) device, an magnetic resonance imaging (MRI) device, Galvanic Skin Response (GSR) monitor, and a heart rate monitor.

12. The system according to claim 8, wherein the salience score comprises an average salience score over a period of time.

13. The system according to claim 8, wherein the threshold value varies over time depending on the first time-based content item.

14. The system according to claim 8, wherein the second time-based content item is selected from a plurality of content based on salience data of the user and historical salience data of other users interacting with the second time-based content item, wherein salience data of the user includes salience scores for time-based content items consumed by the user.

15. A non-transitory computer-readable medium having encoded therein programming code executable by a processor to perform operations comprising:
providing a first time-based content item to a user through a user interface;
receiving physiological data from at least one physiological sensor as the user interacts with the first time-based content item;
determining a salience score based at least in part on the physiological data; and
in the event the salience score is below a threshold value, presenting a second time-based content item to the user through the user interface.

16. The non-transitory computer-readable medium according to claim 15, wherein the first time-based content item comprises content selected from a group consisting of a video, music, a slide show, a presentation, and an animation.

17. The non-transitory computer-readable medium according to claim 15, wherein the physiological data comprises one or more data selected from a group consisting of eye tracking data, electroencephalography (EEG) data, magnetic resonance imaging (MRI) data, and heart rate data.

18. The non-transitory computer-readable medium according to claim 15, wherein the salience score is an average salience score over a period of time.

19. The non-transitory computer-readable medium according to claim 15, wherein the threshold value varies over time depending on the first time-based content item.

20. The non-transitory computer-readable medium according to claim 15, wherein the second time-based content item is selected from a plurality of content based on salience data of the user and historical salience data of other users interacting with the second time-based content item, wherein salience data of the user includes salience scores for time-based content items consumed by the user.
